(19) United States
(12) Patent Application Publication
(10) Pub. No.: US 2005/0186911 A1
(43) Pub. Date: Aug. 25, 2005

(54) Mobile phone having composite material for self-cleaning

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/990,070

(22) Filed: Nov. 16, 2004

(30) Foreign Application Priority Data
Feb. 20, 2004 (TW) 93104250

(51) Int. Cl. H04B 7/00

(52) U.S. Cl. 455/66.1

(57) ABSTRACT

A mobile phone (6) includes a top shell (10), a keymat (20), a main body (30), and a base shell (40). The top shell and the base shell are coupled together to cover the keymat and the main body. A composite coating (60) is formed on outsides of the top shell and the base shell. The composite coating comprises a photocatalyst material and silver. The photocatalyst material can be titanium dioxide (TiO₂) or an oxide of zinc (ZnOₓ). The silver can be in the form of silver paste, silver nano-powder, or silver nano-capsules. The proportion of the photocatalyst material to the silver is 1:1 by weight. The photocatalyst material combined with silver enables bacteria and contaminants to be easily removed from the top and base shells regardless of whether or not the mobile phone is exposed to light.

### BACKGROUND OF THE INVENTION

1. Field of the Invention

The present invention relates to a mobile phone, and more particularly to a self-cleaning mobile phone utilizing a surface composite material.

2. Description of Prior Art

Almost all commercial mobile phones are operated manually. Commands or information are input by pressing keys of the mobile phone. Accordingly, bacteria and other contaminants readily accumulate on the mobile phone. A soiled mobile phone may become a source of irritation, infection, and illness.

Photocatalyst materials (such as titanium dioxide and oxides of zinc) have been utilized to solve such problems. For instance, Taiwan Issued Patent No. 68320 entitled “Method for Arranging Photocatalyst Material on a Transmitter of a Telephone” discloses a mobile phone which is represented as item 1 in FIG. 3 hereof. A photocatalyst material is provided on a shell 11 of the phone 1. The method includes incorporating the photocatalyst material into a raw material of the shell 11 during a process of forming the shell 11. The photocatalyst material is thereby uniformly distributed in the shell 11. The shell 11 can avoid surface buildup of bacteria, and can be easily cleaned.

Nevertheless, a light source is necessary to activate the photocatalyst material so that it can clean the shell 11. The photocatalyst material is inactive in the dark. In particular, bacteria and contaminants can easily accumulate on the shell 11 at night. Further, the method only utilizes a pure photocatalyst material. There are no additives to enhance the cleaning effect of the pure photocatalyst material.

### SUMMARY OF THE INVENTION

In view of the above-described shortcomings, an object of the present invention is to provide a mobile phone which is self-cleanable at all times.

In order to achieve the object set out above, a mobile phone in accordance with a preferred embodiment of the present invention comprises a main body, and a two-part cover coupled to the main body. The cover comprises a top shell and a base shell. The top and base shells comprise a composite material for self-cleaning in at least outside layer portions thereof The composite material comprises a photocatalyst material having photocatalyst nanoparticles and silver.

Preferably, sizes of the photocatalyst nanoparticles are in the range from 15 to 50 nanometers. The photocatalyst material can be selected from the group consisting of titanium dioxide (TiO₂) and oxides of zinc (ZnOₓ). The silver comprises a plurality of silver particles, and sizes of the silver particles are in the range from 1 to 5 nanometers. The form of silver can be selected from the group consisting of silver paste, silver nano-powder, and silver nano-capsules. The proportion of the photocatalyst material to the silver is 1:1 by weight.

Moreover, each outside layer portion preferably has a thickness in the range from 20 to 500 nanometers. The outside layer portion is formed on the top and base shells by spraying, coating or depositing, or by immersing the top and base shells in a solution containing the photocatalyst material and silver for a period of time. In alternative embodiments, each of the top and base shells may comprise the composite material through an entirety thereof. The composite material may further comprise particles containing either gold or platinum, or both gold and platinum.

In the present invention, the photocatalyst material is combined with silver in order to thoroughly and easily remove bacteria and contaminants from the top and base shells of the mobile phone. When the mobile phone 6 is exposed to light, the photocatalyst material is activated. Simultaneously, silver ions are also working. Thus the cleaning effect of the composite material is enhanced. When the mobile phone is not exposed to light, the photocatalyst material is not active. However, the silver ions can continue to kill bacteria. Overall, the present invention provides cleaning of the mobile phone all day and all night regardless of the particular light conditions.

These and other features, aspects and advantages of the invention will become more apparent from the following detailed description and claims, and the accompanying drawings.

### BRIEF DESCRIPTION OF THE DRAWINGS

FIG. 1 is an exploded, isometric view of a mobile phone in accordance with the preferred embodiment of the present invention.

FIG. 2 is a cross-sectional view of part of a top shell of the mobile phone of FIG. 1, taken along line II-II thereof.

FIG. 3 is a front elevational view of a conventional mobile phone.

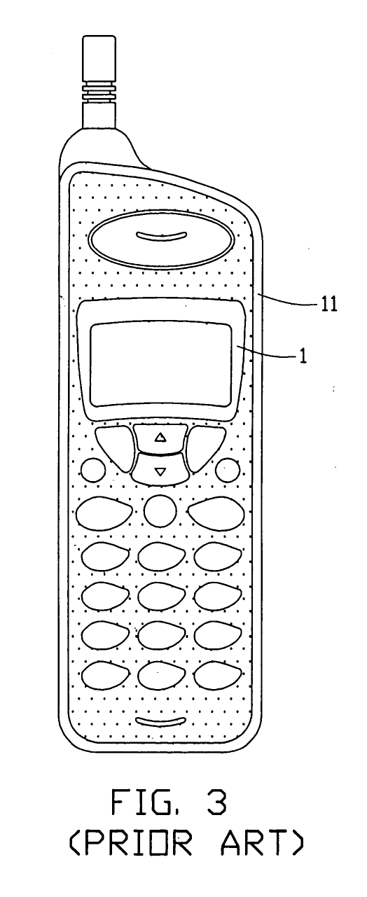

### DETAILED DESCRIPTION OF THE PREFERRED EMBODIMENTS OF THE PRESENT INVENTION

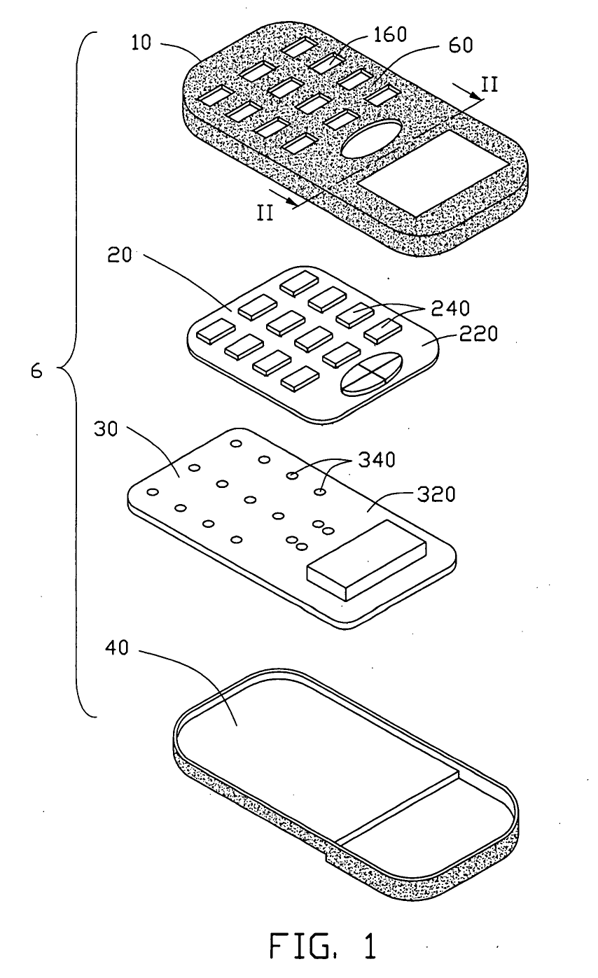

With reference to FIG. 1, there is shown a hand-held device like a mobile phone 6 in accordance with the preferred embodiment of the present invention. The mobile phone 6 comprises a top shell 10, a keymat 20, a main body 30, and a base shell 40. The top shell 10 and the base shell 40 are coupled together to cover the keymat 20 and the main body 30. A composite coating 60 is formed on exteriors of the top shell 10 and the base shell 40, respectively. A material of the composite coatings 60 comprises a photocatalyst material having photocatalyst nanoparticles and silver (Ag).

In the preferred embodiment, the keymat 20 comprises a body sheet 220, and a plurality of keys 240 formed on the body sheet 220. When the mobile phone 6 is assembled, the keymat 20 is interposed between the main body 30 and the top shell 10. The keys 240 extend through corresponding keyholes 160 of the top shell 10.

The main body 30 comprises a circuit board 320, and a plurality of conductive keypoints 340 formed on the circuit board 320. The keypoints 340 are generally made of conductive rubber. Each keypoint 340 corresponds to at least one of working portions (not shown) on the circuit board 320. When a certain key 240 is depressed, an electrical connection is thereby established between the keypoint 340 and one or more corresponding working portions on the circuit board 320. When the key 240 is released, the keypoint 340 resiliently disconnects from said working portions and returns to its normal state.

The top shell 10 and the base shell 40 are provided for protecting the main body 30 from external contamination and impact. The top shell 10 and the base shell 40 are contoured to fit the main body 30.

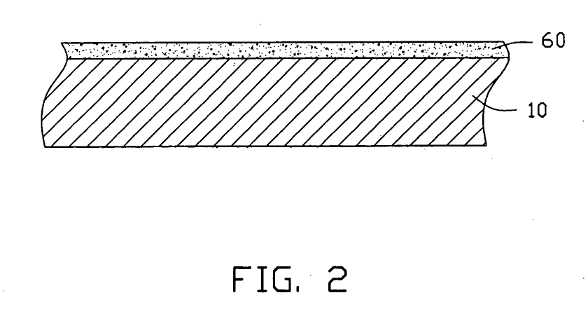

As shown in FIG. 1 and FIG. 2, the top shell 10 and the base shell 40 are covered by the composite coatings 60. Each composite coating 60 has an average thickness in the range from 20 to 500 nanometers. The composite coating 60 comprises the photocatalyst material as its first ingredient and silver as its second ingredient in relative proportions of 1:1 by weight.

The photocatalyst material can be selected from any one or more of titanium dioxide (TiO₂), oxides of zinc (ZnOₓ), and other suitable materials. Preferably, sizes of the photocatalyst nanoparticles are in the range from 15 to 50 nanometers.

The form of silver used can be selected from silver paste, silver nano-powder, silver nano-capsules, and the like. Preferably, the silver comprises a plurality of silver particles, and sizes of the silver particles are in the range from 1 to 5 nanometers.

It should be noted that the proportion by weight of the photocatalyst material to the silver in each composite coating 60 may be determined according to actual need. Every unit of the silver material is preferably surrounded by some of the photocatalyst material to form the composite coatings 60.

In the preferred embodiment, the composite coatings 60 are formed on the top shell 10 and the base shell 40 by spraying, coating or depositing. Alternatively, the top shell 10 and the base shell 40 may be immersed in a solution containing the photocatalyst material and silver, for a period of time sufficient to uniformly form the composite coatings 60 on the top shell 10 and base shell 40.

In an alternative embodiment, the photocatalyst material and silver may be incorporated in a raw material of the top shell 10 and the base shell 40. If so, the particles of the photocatalyst material and silver are uniformly distributed throughout an entirety of each of the top shell 10 and the base shell 40, instead of being merely in the composite coatings 60 thereof.

Moreover, particles containing gold (Au) or platinum (Pt) may be included with the photocatalyst material, in order to enhance decomposition of carbon monoxide.

The operational principles of each composite coating 60 are explained in detail below.

When irradiated by ultraviolet light having a wavelength less than or equal to 380 nanometers, particles of titanium dioxide (TiO₂) (an example of a photocatalyst material) react with adjacent molecules of water and oxygen. A plurality of hydrogen ions (H⁺), hydroxyl ions (OH⁻), and free radicals having strong reductive and oxidative capabilities (such as O⁻, O₂⁻, and O₃⁻) are produced by such reactions. Thus, contaminants on a surface of the shell 10, 40 can be decomposed by the free radicals and then easily removed. In addition, large water droplets cannot easily form on the surface, due to the presence of hydrogen ions (H⁺) and hydroxyl ions (OH⁻) thereon. A contact angle between any water droplet and the surface is reduced to a value close to zero, which is significantly less than a corresponding contact angle in the case where no photocatalyst material is used. That is, the surface is rendered super hydrophilic after irradiation by ultraviolet light. In summary, after ultraviolet light irradiation, most of bacteria and contaminants on the surface are easily and substantially removed.

In similar fashion to the photocatalyst material, the silver can react with adjacent molecules of water and oxygen. A plurality of free radicals having strong reductive and oxidative capabilities (such as O⁻, O₂⁻, and O₃⁻) are thereby produced. In particular, a plurality of silver ions (Ag⁺) having strong reductive capability are produced. Even at low concentrations, the silver ions can easily break the cell walls of bacteria and kill them. Furthermore, the number of silver ions does not be decrease significantly after reaction with bacteria. The silver ions become dissociated from the killed bacteria, and then continue to react with and kill other live bacteria.

In the present invention, the photocatalyst material is combined with silver in order to remove bacteria and contaminants from the mobile phone 6.

When the mobile phone 6 is exposed to light, the photocatalyst material is activated. Simultaneously, silver ions are also working. Thus the cleaning effect is enhanced. When the mobile phone 6 is not exposed to light, the photocatalyst material is not active. However, the silver ions can continue to kill bacteria. Overall, the present invention provides cleaning of the mobile phone 6 all day and all night regardless of the particular light conditions.

It should be understood by those skilled in the art that other composite coatings 60 may also be formed on other parts of the mobile phone 6, such as the keys 240 of the keymat 20.

It should be further noted that the above-described mobile phone 6 has been provided for the purposes of illustrating the present invention. The mobile phone 6 is not critical to practicing the present invention. A variety of conventional mobile phones are known to those skilled in the art, and these may be suitably adapted for practicing the present invention. In particular, the top shell 10 and the base shell 40 are exemplified herein for illustration purposes only, and are not intended to limit the present invention.

Finally, while the present invention has been described with reference to particular embodiments, the description is illustrative of the invention and is not to be construed as limiting the invention. Therefore, various modifications can be made to the preferred embodiments by those skilled in the art without departing from the true spirit and scope of the invention as defined by the appended claims.

1. A mobile phone comprising:
a main body, and
a cover coupled to the main body,
wherein the cover comprises a composite material for self-cleaning in at least an outside layer portion thereof, the composite material comprising a photocatalyst material having photocatalyst nanoparticles and silver.

2. The mobile phone as claimed in claim 1, wherein sizes of the photocatalyst nanoparticles are in the range from 15 to 50 nanometers.

3. The mobile phone as claimed in claim 1, wherein the photocatalyst material is selected from the group consisting of titanium dioxide (TiO₂) and oxides of zinc (ZnOₓ).

4. The mobile phone as claimed in claim 1, wherein the form of silver is selected from the group consisting of silver paste, silver nano-powder, and silver nano-capsules.

5. The mobile phone as claimed in claim 1, wherein the silver comprises a plurality of silver particles, and sizes of the silver particles are in the range from 1 to 5 nanometers.

6. The mobile phone as claimed in claim 1, wherein the outside layer portion has a thickness in the range from 20 to 500 nanometers.

7. The mobile phone as claimed in claim 1, wherein the outside layer portion is formed on the cover by spraying, coating or depositing, or by immersing the cover in a solution containing the photocatalyst material and silver for a period of time.

8. The mobile phone as claimed in claim 1, wherein the cover comprises the composite material throughout an entirety thereof.

9. The mobile phone as claimed in claim 1, wherein the composite material further comprises particles containing either gold or platinum, or both gold and platinum.

10. The mobile phone as claimed in claim 1, wherein the proportion of the photocatalyst material to the silver is 1:1 by weight.

11. The mobile phone as claimed in claim 1, further comprising a keymat interposed between the cover and the main body, the keymat comprising the composite material in at least outside layer portions thereof.

12. A mobile phone comprising:
a main body;
a cover defining a plurality of through holes; and
a keymat having a plurality of keys and being located between the cover and the main body, the keys extending upwardly through the through holes, respectively;
wherein the cover comprises a photocatalyst material having photocatalyst nanoparticles and silver at an outer surface thereof, the photocatalyst material and the silver cooperatively providing self-cleaning of the cover under any and all light conditions.

13. The mobile phone as claimed in claim 12, wherein the keymat comprises the photocatalyst material and silver at outer surfaces thereof.

14. The mobile phone as claimed in claim 12, wherein sizes of the photocatalyst nanoparticles are in the range from 15 to 50 nanometers.

15. The mobile phone as claimed in claim 12, wherein the photocatalyst material is selected from the group consisting of titanium dioxide (TiO₂) and oxides of zinc (ZnOₓ).

16. The mobile phone as claimed in claim 12, wherein the form of silver is selected from the group consisting of silver paste, silver nano-powder, and silver nano-capsules.

17. The mobile phone as claimed in claim 12, wherein the silver comprises a plurality of silver particles, and sizes of the silver particles are in the range from 1 to 5 nanometers.

18. A hand-held device comprising:
a main body with a cover shielding outside said main body to allow hand-contact thereon; and
composite material comprised in said cover, and having a first ingredient of light-sensitivity and a second ingredient of possession of metal ions so as to generate cleaning effect on said cover based on light-illuminating reaction of said first ingredient and ion-based cleaning of said second ingredient.

19. The hand-held device as claimed in claim 18, wherein said first ingredient is photocatalyst material having photocatalyst nanoparticles and said second ingredient is silver.

20. The hand-held device as claimed in claim 18, wherein said second ingredient is surrounded by said first ingredient to form portions of said composite material.
